(19) United States
(12) Patent Application Publication
(10) Pub. No.: US 2018/0108277 A1
(43) Pub. Date: Apr. 19, 2018

(54) SIGN FOR DISPLAYING CHANGEABLE INFORMATION

(71) Applicant: INTERIOR GRAPHIC SYSTEMS, LLC, North Canton, OH (US)

(72) Inventor: James T. Weisburn, North Canton, OH (US)

(73) Assignee: INTERIOR GRAPHIC SYSTEMS, LLC

(21) Appl. No.: 15/296,420

(22) Filed: Oct. 18, 2016

(51) Int. Cl. G09F 1/10; G09F 1/02

(52) U.S. Cl. CPC G09F 1/10; G09F 1/02

(57) ABSTRACT

A display sign mountable on a support surface where at least some of the information displayed thereon needs to be changed periodically. The sign includes a housing with one or more pockets defined therein, where an interior of each pocket is visible through an associated window on the housing. A set of display cards is receivable in each pocket in the housing. Each display card has different text or graphics thereon. Individual display cards may be selectively withdrawn from the set of display cards by grasping a tab on that particular display card and pulling the display card out of the pocket. The removed display card may be inserted in front of an outermost display card that was previously visible through the associated window. A single display card that is free of tabs may be inserted into one of the pockets and remain substantially permanently visible through the associated window.

### BACKGROUND

### Technical Field

This invention relates generally to signs for displaying information. More particularly this invention is directed to display signs that may be mounted on a support surface such as a building wall, where at least some of the displayed information on the sign needs to be changed periodically. Specifically, this invention relates to a sign comprising a housing with one or more pockets defined therein, where an interior of each pocket is visible through an associated window on the housing; and one or more sets of display cards, each display card including different text or graphics thereon; each set of display cards being received in different pocket of the housing; and wherein individual display cards may be withdrawn from the set of display cards and be inserted in front of an outermost display card that was previously visible through the associated window.

### Background Information

It is quite common for large office buildings, universities, hospitals and other institutions to mount informational signs on a wall adjacent an entry to a room in the building or institution. This informational sign is provided to let visitors or users know what business, doctor, service etc. is provided in that particular room or sector of the building.

The function of a particular room or sector of a building may change from time to time and this likely will require the information on the informational sign to be changed. Depending on the function or service the room provides, the information displayed on the sign may need to be changed more than once a day, once every few days, weekly, once a month or term or every few years. Furthermore, only some of the information may need to be changed on the sign while other information needs to remain constant. For example, in a hospital a display sign may be needed to permanently show the service provided in that particular room but the name of an attending physician working in that room may need to change every shift. In a university, the name of a particular laboratory or faculty office need to be displayed permanently but other information such as a course name or number or the name of a professor teaching that class may need to change every hour.

### SUMMARY

There is therefore a need in the art for a display sign that enables information displayed therein to be changed quickly and easily.

The changeable sign disclosed herein serves this purpose. The display sign includes a housing with one or more pockets defined therein; where an interior of each pocket is visible through an associated window on the housing. A set of display cards is receivable in each pocket in the housing. Each display card has different text or graphics thereon. Individual display cards may be selectively withdrawn from the set of display cards by grasping a tab on that particular display card and pulling the display card out of the pocket. The removed display card may be inserted in front of an outermost display card that was previously visible through the associated window. A single display card that is free of tabs may be inserted into one of the pockets and remain substantially permanently visible through the associated window.

In one aspect, a changeable sign may comprise: a housing having a front wall and a rear wall; a pocket defined in the housing; a window provided on the front wall, wherein an interior of the pocket is visible through the window; and one or more display cards shaped and sized to be received in the pocket; wherein each of the one or more display cards has different text or images thereon; and wherein the one or more display cards form a set of display cards that is receivable in the pocket; and when the set of display cards is so received, the text or images on an outermost display card of the set of display cards is visible through the window.

Each of the one or more display cards may have an upper edge and a side edge; and a tab may extend outwardly from the side edge; and when the set of display cards is received in the pocket, the tab of each of the one or more display cards may extend outwardly beyond a side edge of the front wall of the housing. The tab of each of the one or more display cards may be located at a distance from the upper edge thereof; and wherein the distance of the tab from the upper edge of each of the one or more display cards in the set of display cards differs from the distances of the tabs of all other display cards in the set of display cards. When the set of display cards is received in the pocket, the tabs of all of the one or more display cards in the set of display cards may be staggered relative to each other. Text or images may be provided on each tab; and when the set of display cards is received in the pocket, the text or images on all the tabs may be visible no matter an order of the display cards in the set of display cards.

In another aspect, a sign for displaying changeable information may comprise a housing having a front wall and a rear wall; a first pocket defined in the housing; a first window provided on the front wall, wherein an interior of the first pocket is visible through the window; at least one additional pocket defined in the housing; wherein the at least one additional pocket is separated from the first pocket; at least one additional window provided on the front wall; wherein an interior of the at least one additional pocket is visible through the at least one additional window; and a first set of display cards shaped and sized to be received in the first pocket; at least one additional set of display cards shaped and sized to be received in one of the one or more additional pockets; wherein each display card in the first set of display cards or the at lest one additional set of display cards has different text or images thereon; and when the set of display cards is so received, the text or images on an outermost display card of the first set of display cards is visible through the first window; and an outermost display card of the at least one additional set of display cards is visible through the at least one additional window.

In another aspect, a method of changing information displayed on a wall sign may comprise the steps of providing a sign comprising a housing having a front wall and a rear wall; a first pocket defined in the housing; a first window provided on the front wall, wherein an interior of the first pocket is visible through the window; inserting a first set of display cards into the first pocket; where the first set of display cards includes one or more display cards that have different graphic images or text thereon; positioning an outermost display card of the one or more display cards adjacent the first window; displaying the text or graphics on the outermost display card through the first window; selecting one of the one or more display cards from a remaining portion of the first set of display cards; removing the selected one of the display cards from the first pocket; and inserting the removed display card in front of the outermost display card; and displaying the text or graphics on the inserted display card through the first window.

In the method, the step of removing the selected one of the display cards may include grasping a tab provided on the selected one of the display cards; pulling on the grasped tab; and sliding the selected one of the display cards out of the first pocket.

The step of providing the housing may further comprise providing at least one additional pocket in the housing; wherein the at least one additional pocket is separated from the first pocket; providing at least one additional window on the front wall of the housing; wherein an interior of the at least one additional pocket is visible through the at least one additional window; and the method may further comprise selecting one of the at least one additional pockets; inserting at least a single display card into the selected one of the at least one additional pockets; and semi-permanently interlocking the inserted single display card into the selected one of the at least one additional pockets.

### BRIEF DESCRIPTION OF THE SEVERAL VIEWS OF THE DRAWINGS

A sample embodiment is set forth in the following description, is shown in the drawings and is particularly and distinctly pointed out and set forth in the appended claims.

FIG. 1 is a front elevation view of a changeable sign in accordance with an aspect of the present invention shown mounted on a building wall;

FIG. 2 is a perspective view of the sign shown on its own;

FIG. 3 is a partial exploded perspective view of the sign showing the display cards separated from the holder;

FIG. 4 is a right side view of the holder; the left side view of the holder will be a mirror image hereof;

FIG. 5 is a longitudinal cross-section of the holder taken along line 5-5 of FIG. 4;

FIG. 6 is an enlargement of the highlighted region of FIG. 5;

FIG. 7 is a front elevation view of a first display card;

FIG. 8 is a front elevation view of a second display card;

FIG. 9 is an enlargement of the highlighted region of FIG. 8;

FIG. 10 is a front elevation view of a third display card;

FIG. 11 is an enlargement of the highlighted region of FIG. 10;

FIG. 12 is a partial longitudinal cross-section of the holder shown in FIG. 5 but with the first, second, and third display cards engaged therewith and showing, in phantom, the second and third display cards partially inserted into the holder;

FIG. 13 is a front elevation of an alternative embodiment of the first display card;

FIG. 14 is a front elevation view of the changeable sign showing a set of display cards engaged in the holder and showing a first set of information on the first, second and third display cards;

FIG. 14A is an enlargement of the highlighted region of FIG. 14 showing the arrangement of the tabs on the cards of the first set of cards;

FIG. 15 is a front elevation view of the changeable sign showing the first and second cards being withdrawn from the holder and the third card remaining engaged with the holder; and

FIG. 16 is a front elevation view the changeable sign showing new first and second cards engaged in the holder to display new information.

Similar numbers refer to similar parts throughout the drawings.

### DETAILED DESCRIPTION

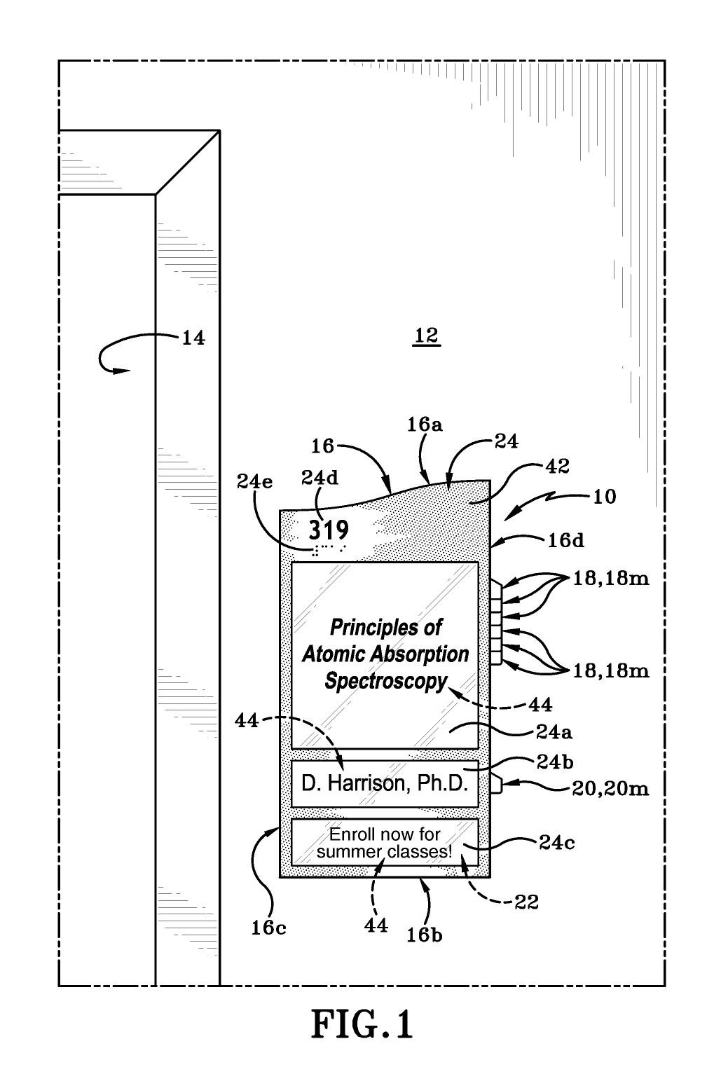

Referring to FIGS. 1-13, there is shown a changeable sign in accordance with an aspect of the present invention, generally indicated at 10. Sign 10 is shown in FIG. 1 mounted on a wall 12 adjacent a doorway 14 into a room. Sign 10 comprises a housing 16 and a plurality of display cards 18, 20, 22. Housing 16 is mounted on wall 12 by any suitable means and display cards 18, 20, 22 are selectively received in housing 16.

Display cards 18, 20, 22 may be provided as a first set of cards 18, a second set of cards 20 and a third set of cards 22. The first set of cards 18 may include a plurality of cards such as the six cards illustrated herein, namely, cards 18A, 18B, 18C, 18D, 18E, and 18F. (Any number of cards may be provided in this first set of cards 18. The second set of cards 20 may include a plurality of cards such as the six cards 20A, 20B, 20C, 20D, 20E and 20F illustrated herein. (Any number of cards may be provided in this second set of cards 20.) Third set of cards 22 may include a plurality of cards but in the instance illustrated herein the third set of cards comprises just a single card 22. The reason for this will be explained later herein.

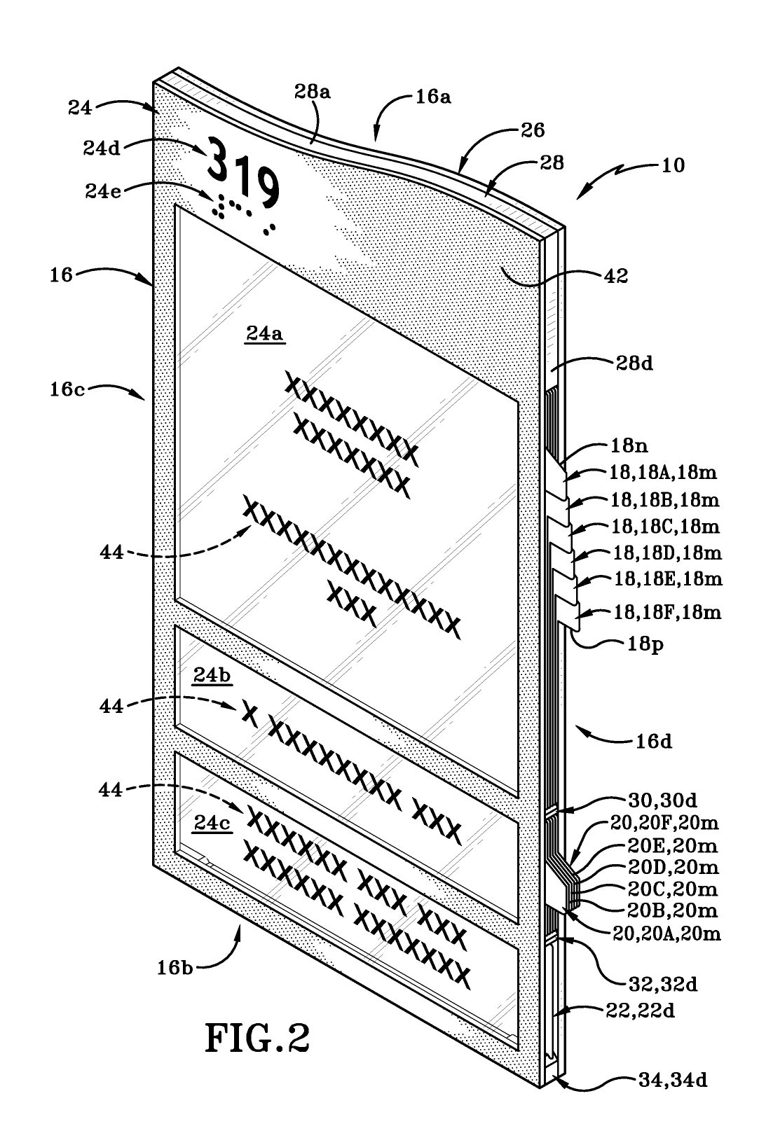

Referring to FIGS. 2-4, housing 16 has an upper end 16a, a lower end 16b, a first side 16c and a second side 16d. Housing also includes a front wall 24, a rear wall 26, a first spacer 28, a second spacer 30, a third spacer 32, and a fourth spacer 34. Rear wall 26 is designed to be located adjacent the exterior surface of building wall 12 and appropriate mounting members (not shown) may be used to secure rear surface 26 to building wall 12.

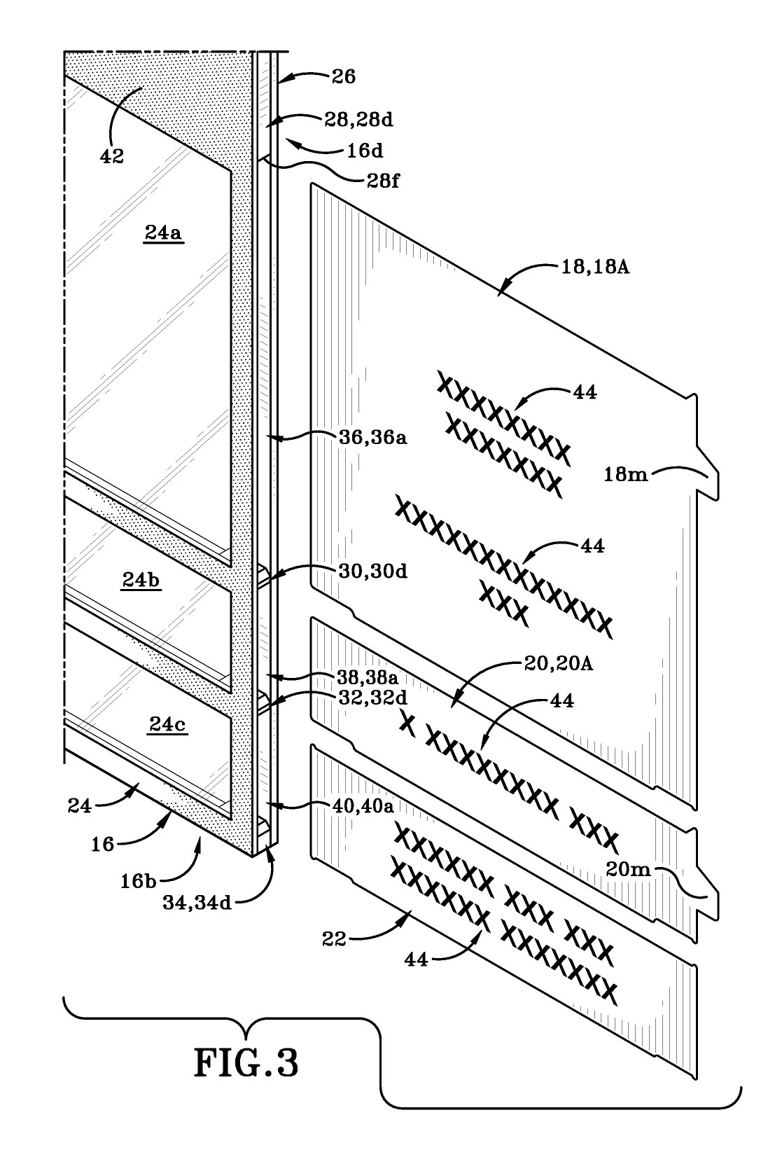

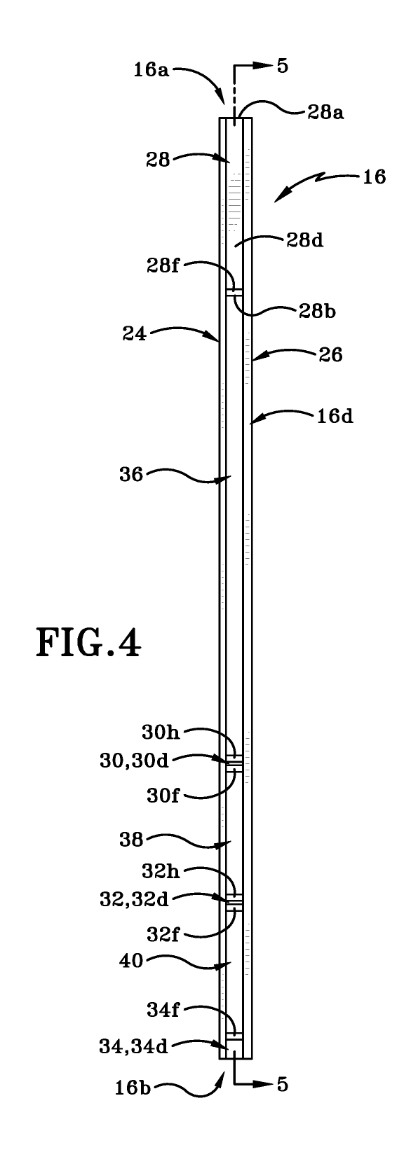

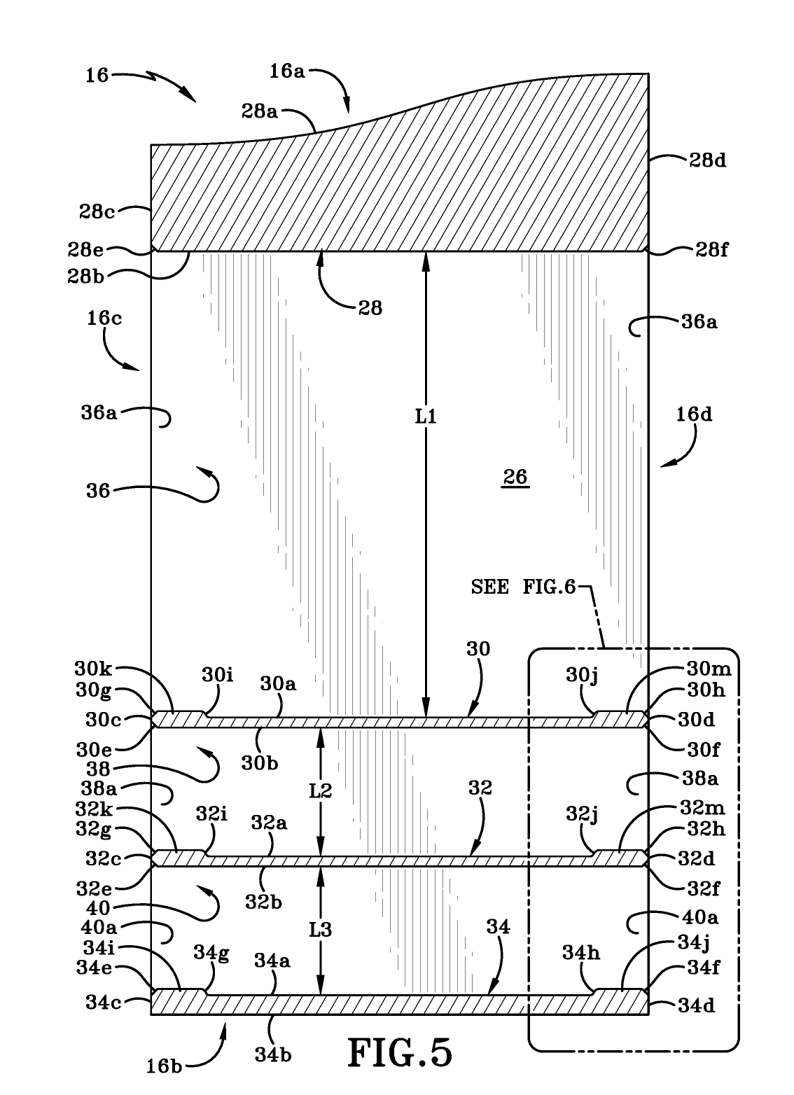

Front wall 24 and rear wall 26 may be molded from a transparent plastic material and are positioned so that there top and bottom edges and left and right side edges are aligned. First, second, third, and fourth spacers 28, 30, 32 and 34 are sandwiched between front wall 24 and rear wall 26. Three pockets are defined within housing 16. A first pocket 36 is defined by the interior surfaces of front wall 24 and rear wall 26, the lower edge 28b of first spacer 28 and the upper edge 30a of second spacer 30 and is accessible through openings in each of first side 16c and second side 16d of housing 16. The opening 36a (FIG. 5) to first pocket 36 in second side 16d may be seen in FIGS. 3 and 4. First pocket 36 may be of a first length “L1” (FIG. 5) defined as the distance between lower edge 28b of first spacer 28 and upper edge 30a of second spacer 30.

A second pocket 38 is defined by the interior surfaces of front wall 24 and rear wall 26, the lower edge 30b of second spacer 30 and the upper edge 32a of third spacer 32 and is accessible through openings 38a (FIG. 5) defined in each of first side 16c and second side 16d of housing 16. The opening to second pocket 38 in second side 16d may be seen in FIGS. 3 and 4. Second pocket may be of a second length “L2” defined as the distance between lower edge 30b and upper edge 32a.

A third pocket 40 is defined by the interior surfaces of front wall 24 and rear wall 26, the lower edge of third spacer 32 and the upper edge 34a of fourth spacer 40 and is accessible through openings 40a (FIG. 5) defined in first side 16c and second side 16d of housing 16. The opening to third pocket 40 in second side 16d may be seen in FIGS. 3 and 4. Third pocket 30 may be of a third length “L3” defined as the distance between lower edge 32b and upper edge 34a.

Front wall 24 includes regions that are covered by an opaque or a translucent covering 42. Covering 42 may be stippling, texturing, color, a decal or any other surfacing that makes regions of front wall opaque or translucent. Three areas of front wall 24 are free of this covering 42 and therefore remain transparent. These three transparent areas are identified in FIG. 3 by the reference numbers 24a, 24b and 24c and form first, second and third windows, respectively, that enable someone looking at sign to see information 44 that is printed on a front surface of each of the cards in the first, second and third sets of cards 18, 20, 22.

As illustrated in FIG. 1, in certain instances graphic text or images 24d may be printed, marked, embossed or otherwise applied to an outermost surface of front wall 24. So, for example, a room number may be provided on front wall 24 as graphic text or images 24d. Furthermore, a braille rendition 24e of that text or image 24d may be provided on front wall 24. It will be understood that this text or image 24d and braille rendition 24e may be provided at any desired position on front wall 24.

FIG. 5 shows the rear wall 26 with the first, second, third and fourth spacers 28, 30, 32, 34. Each spacer 28-34 is configured to engage a portion of the cards of one of the three sets of cards 18, 20, 22 and to thereby aid in retaining those cards in the associated first, second or third pocket 26, 38, 40.

First spacer 28 has an upper edge 28a, a lower edge 28b, a first side edge 28c and a second side edge 28d. Upper edge 28a may have any desired configuration. In the instance illustrated in the attached figures, upper edge 28a conforms to the upper edges of each of the front and rear walls 24, 26 and is curved. Lower edge 28b is substantially flat to accommodate the shape of the upper ends of the cards of the third set of cards 18 that are configured to be received in first pocket 34. A first chamfer 28e is provided at the junction of first side 28c and lower edge 28b. First chamfer 28e angles inwardly and downwardly toward the interior of first pocket 34 and away from first side 28c. A second chamfer 28f is provided at the junction of second side 28d and lower edge 28b. Second chamfer 28f angles inwardly and downwardly toward the interior of first pocket 34 and away from second side 28c. The angle of the first and second chamfers 28e, 28f is such that each of the cards of the first set of cards 18 that are inserted into first pocket 36 will be guided inwardly into first pocket 36.

Second spacer 30 has an upper edge 30a, a lower edge 30b, a first side 30c and a second side 30d. Lower edge 30b of second spacer 30 is substantially identical to lower edge 28b of first spacer 28. Lower edge 30b is therefore substantially flat and straight along its length except for a first chamfer 30e and a second chamfer 30f that are provided at the junction of lower edge 30b and first side 30c and second side 30d, respectively. First and second chamfers 30e, 30f are provided to aid in guiding cards from the second set of cards 20 into second pocket 38. Upper edge 30a of second spacer 30 also includes a first chamfer 30g at the junction of upper edge 30a and first side 30c and a second chamfer 30h at the junction of upper edge 30a and second side 30d. First chamfer 30g is angled in the opposite direction to first chamfer 30e and second chamfer 30h is angled in the opposite direction to second chamfer 30f. First and second chamfers 30g, 30h are provided to guide cards from the second set of cards 20 into second pocket 38.

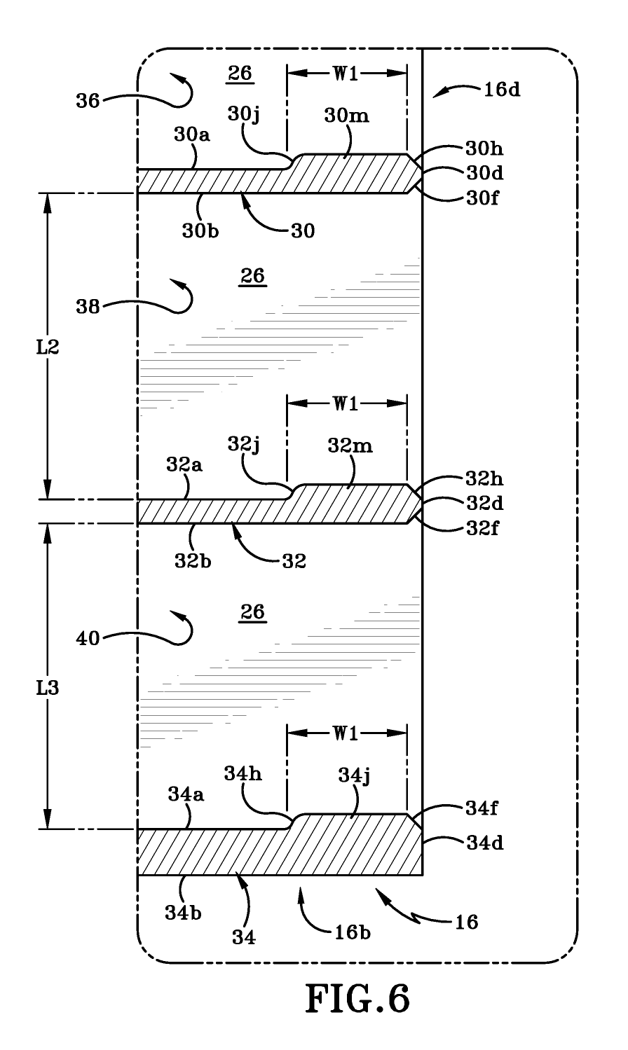

In addition to the first and second chamfers 30g, 30h, upper edge 30a also defines a recessed region therein that has a first curved shoulder 30i at one end and a second curved shoulder 30j at the other end. First curved shoulder 30i is oriented at an angle opposite to that of first chamfer 30g and second curved shoulder 30j is oriented at an angle opposite to that of second chamfer 30h. Thus a pair of projections 30k and 30m extends upwardly into first pocket 36 as is shown in FIG. 5. Projections 30k, 30m may be of a width “W1” (FIG. 6). Projections 30k and 30m and the shoulders associated therewith, namely 30i and 30j, limit the lateral travel of the cards of the first set of cards 18 received in first pocket 36. This will be described later herein.

Third spacer 32 is substantially identical in structure and function to second spacer 30 and therefore will not be described in any additional detail other than to say that third spacer 32 has an upper edge 32a, a lower edge 32b, a first side 32c and a second side 32d. Third spacer also includes a first chamfer 32e, a second chamfer 32f, another first chamfer 32g, and another second chamfer 32h, a first shoulder 32i, a second shoulder 32j, a first projection 30k and a second projection 32m. First and second chamfers 30e, 30f aid in guiding cards from the third set of cards 22 into third pocket 40 and first and second chamfers 32g, 32h aid in guiding cards from the second set of cards 20 into second pocket 38. Projections 32k, 32m may be of a width “W1” (FIG. 6). Projections 32k and 32m and the shoulders associated therewith, namely 32i and 32j, limit the lateral travel of cards 20 received in second pocket 38. This will be described later herein.

Fourth spacer 34 has an upper edge 34a, a lower edge 34b, a first side 34c and a second side 34d. Lower edge 34b is substantially flat and straight from first side 34c to second side 34d. Upper edge 34a is substantially similarly shaped to upper edges 30a and 32a. Upper edge 34a includes a first chamfer 34e at the junction of first side 34c and upper edge 34a and a second chamfer 34f at the junction of second side 34d and upper edge 34a. First and second chamfer's 34e, 34f angle inwardly and upwardly away from first and second sides 34c, 34d and into third pocket 40. First and second chamfer's 34e, 34f aid in directing cards from the third set of cards 22 into third pocket 40.

Upper edge 34a further comprises a recessed region and a first shoulder 34g is provided at one end of the recessed region and a second shoulder 34h is provided at the opposite end of the recessed region. A first projection 34i is defined between first chamfer 34e and first shoulder 34g and a second projection 34j is defined between second chamfer 34f and second shoulder 34h. Projections 34i and 34j may be of a width “W1” (FIG. 6). Projections 34i and 34j and the shoulders associated therewith, namely 34g and 34h, limit the lateral travel of cards 22 received in third pocket 40. This will be described later herein.

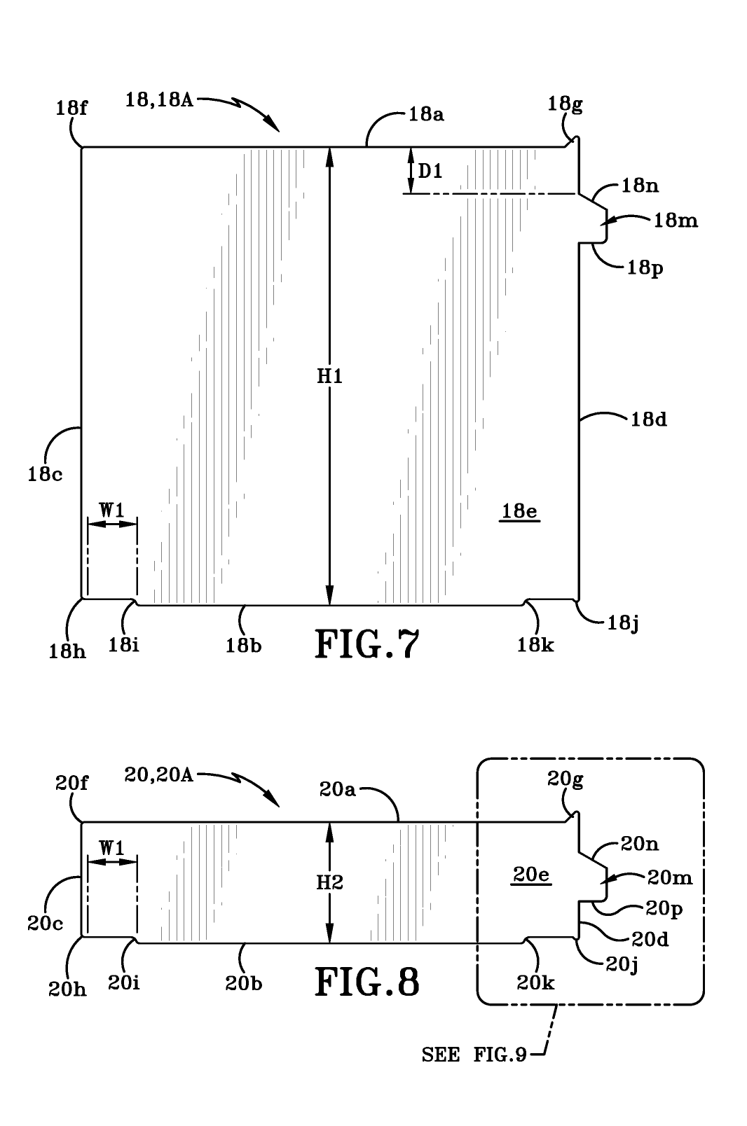

FIG. 7 shows one card 18A from the first set of cards 18. All of the cards 18A-18F of the first set of cards 18 are substantially identical except for one region thereof. This exception will be described later herein. Card 18A has an upper edge 18a, a lower edge 18b, a first side 18c a second side 18d, and a front surface 18e (a rear surface is located opposite front surface 18e but is not illustrated herein). Upper edge 18a meets first side 18b at a first corner 18f. First corner 18f is gently rounded. Upper edge 18a meets second side 18d at a second corner 18g. Second corner 18g is shaped as a triangular projection that extends upwardly beyond the rest of upper edge 18a. This triangular projection acts as a limiting member that engages a portion of the housing 16 and limits the degree to which card 18A may be inserted into first pocket 36, i.e., how far the card 18A may slide into first pocket 36. First card 18A may be of a height “H1” (FIG. 7) defined as the distance between upper edge 18a and lower edge 18b. Height “H1” may be shorter than length “L1” of first pocket 36.

Lower edge 18b meets first side 18c at a third corner 18h that is gently rounded in a similar fashion to first corner 18f. Third corner 18h is part of a recessed region on lower edge 18b that is complementary in shape to first projection 30k on second spacer 30. A first shoulder 18i is provided a distance inwardly from third corner 18h and first shoulder is complementary to first shoulder 30i on second spacer 30. Lower edge 18b meets second side 18d at a fourth corner 18j. The fourth corner 18j includes a small rounded projection that is positioned and sized to engage second chamfer 30h on second spacer 30. The small rounded projection is also a limiting member that limits the extent or degree to which card 18A may move or travel into first pocket 36. Fourth corner 18j is part of a second recessed region on lower edge 18b. A second shoulder 18k is provided a distance inwardly from fourth corner 18j and is complementary to second shoulder 30j on second spacer 30. First and second recessed regions on lower edge 18b may each be of a width “W1” (FIG. 7).

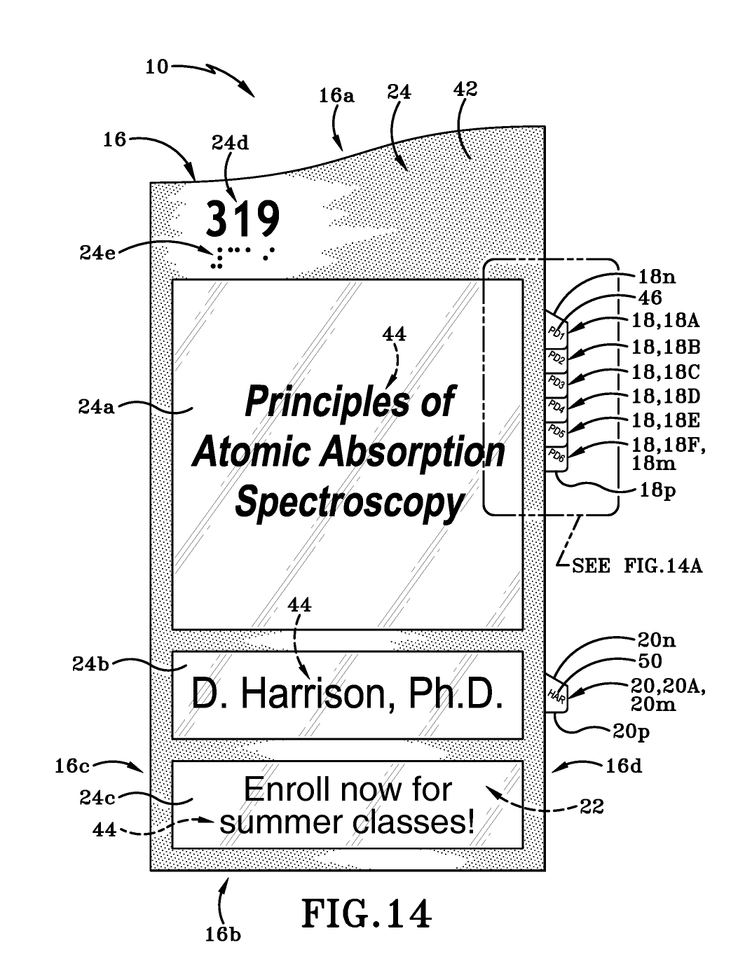

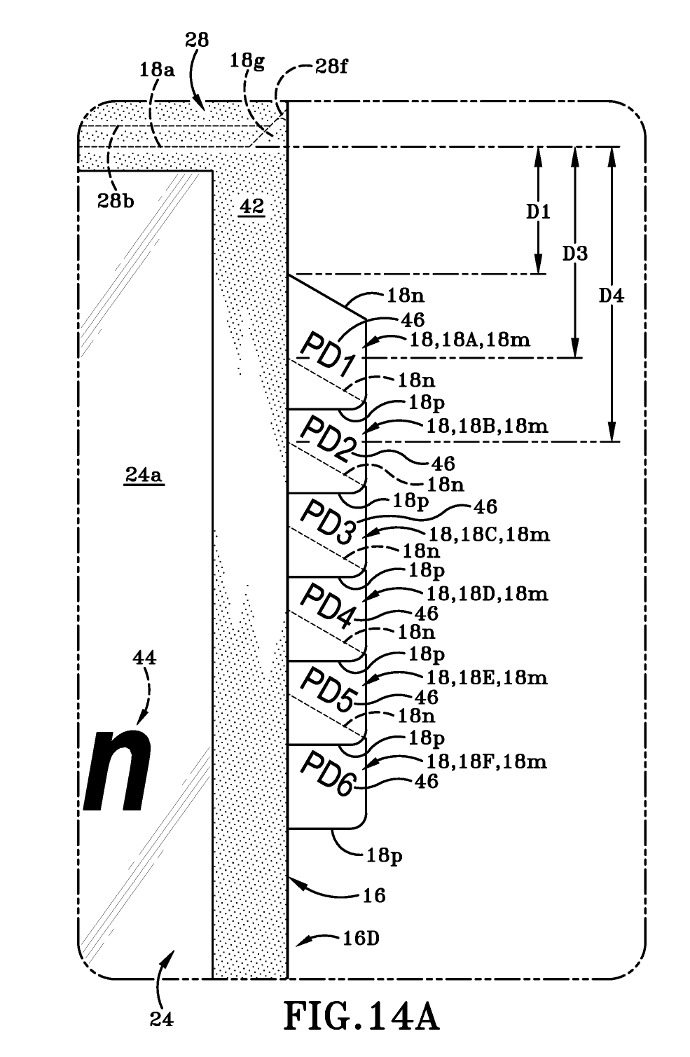

A tab 18m extends outwardly away from second side 18d. Tab 18m is located a distance “D1” from upper edge 18a and includes a first end 18n that slopes downwardly away from second side 18d in a direction extending away from upper edge 18a. Tab 18m also includes a second end 18p that is oriented generally at right angles to second side 18d. As indicated earlier herein, all of the cards 18A-18F are substantially identical except in one aspect. That aspect is that the location of the tab 18m on each card is a different distance away from upper edge 18a of the associated card. This can be seen in FIGS. 2 and 14, for example. The first tab 18m on the first card 18A is located a distance “D1” (FIGS. 7 and 14A) from upper edge 18a of that card. The first tab 18m on the second card 18B is located a distance “D3” (FIG. 14A) from upper edge 18a; the third tab 18m on third card 18C is located a distance “D4” from upper edge 18a. The configuration of tabs 18m and the differing distances of tabs 18m from upper edge 18a all ensure that a region of each tab 18m is always visible to a viewer, no matter what order cards 18A-18F are arranged in. Additionally, each tab 18m includes information text or informational images 46 (FIGS. 46) thereon. In accordance with an aspect of the invention, text or images 46 is oriented at an angle that is substantially parallel to the angled first end 18n of tab 18m. Text or images 46 is also spaced a distance downwardly from first end 18n so that when cards 18A-18F overlap each other the text or images 46 on each and every tab 18m remains readable, no matter the physical order of the cards 18A-18F in first pocket 36.

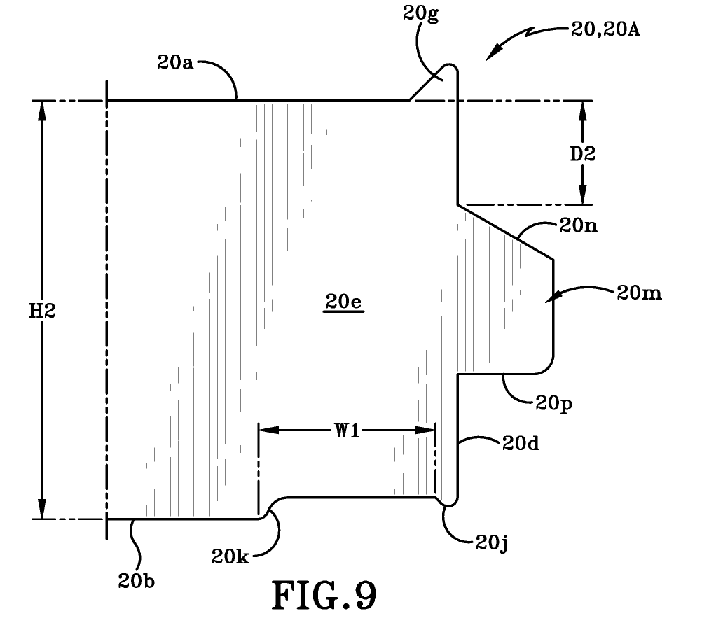

FIGS. 8 and 9 show one card 20A from the second set of cards 20. All of the cards 20A-20F in the second set of cards 20 are substantially identical to each other. Card 20A has an upper edge 20a, a lower edge 20b, a first side 20c, a second side 20d, and a front surface 20e (a rear surface is located opposite front surface 20e but is not illustrated herein). Card 20A may be of a height “H2” (FIG. 8) defined as the distance between upper edge 20a and lower edge 20b. Height “H2” is shorter than length “L2” of second pocket 38.

Upper edge 20a meets first side 20b at a first corner 20f. First corner 20f is gently rounded. Upper edge 20a meets second side 20d at a second corner 20g. Second corner 20g is shaped as a triangular projection that extends upwardly beyond the rest of upper edge 20a. Second corner 20g acts as a limiting member that halts the travel of display card 20A into second pocket 38 when second corner 20g encounters second chamber 30f on second spacer 30.

Lower edge 20b meets first side 20c at a third corner 20h that is gently rounded in a similar fashion to first corner 20f. Third corner 20h is part of a recessed region on lower edge 20b that is complementary in shape to first projection 32k on third spacer 32. A first shoulder 20i is provided a distance inwardly from third corner 20h and first shoulder 20i is complementary to first shoulder 32i on third spacer 32. (First shoulder 32i is a limiting member that limits the degree to which card 20A can travel into the second pocket 38.) Lower edge 20b meets second side 20d at a fourth corner 20j. The fourth corner 20j includes a small rounded projection that is positioned and sized to engage second chamfer 32h on third spacer 32. Fourth corner 20j is part of a second recessed region on lower edge 20b. A second shoulder 20k is provided a distance inwardly from fourth corner 20j and is complementary to second shoulder 32j on third spacer 32. First and second recessed regions may be of a width “W1” (FIG. 8).

A tab 20m extends outwardly away from second side 20d. Tab 20m is located a distance “D2” from upper edge 20a and includes a first end 20n that slopes downwardly away from second side 20d in a direction extending away from upper edge 20a. Tab 20m also includes a second end 20p that is oriented generally at right angles to second side 20d. When a plurality of cards 20A-20F are stacked one-in-front of the other to form the second set of cards 20, all of the tabs 20m are aligned with each other instead of being staggered. Only the tab 20m of the outermost card is visible from the front and the rest of the tabs 20m are stacked one behind the other.

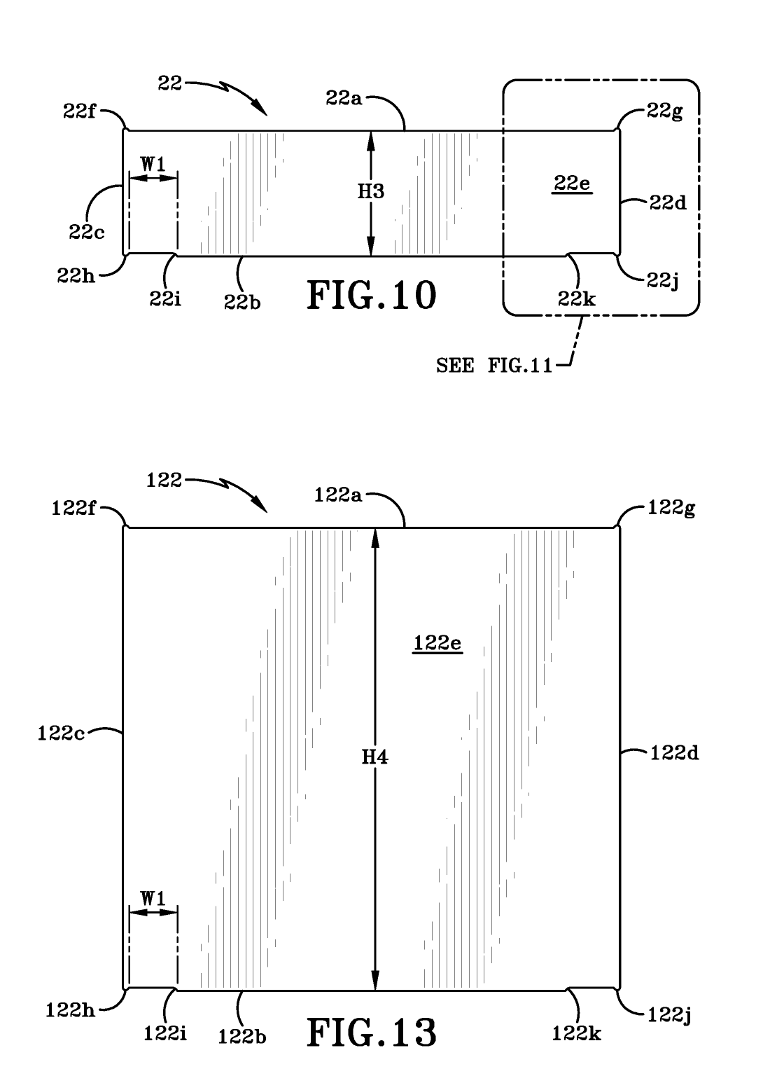

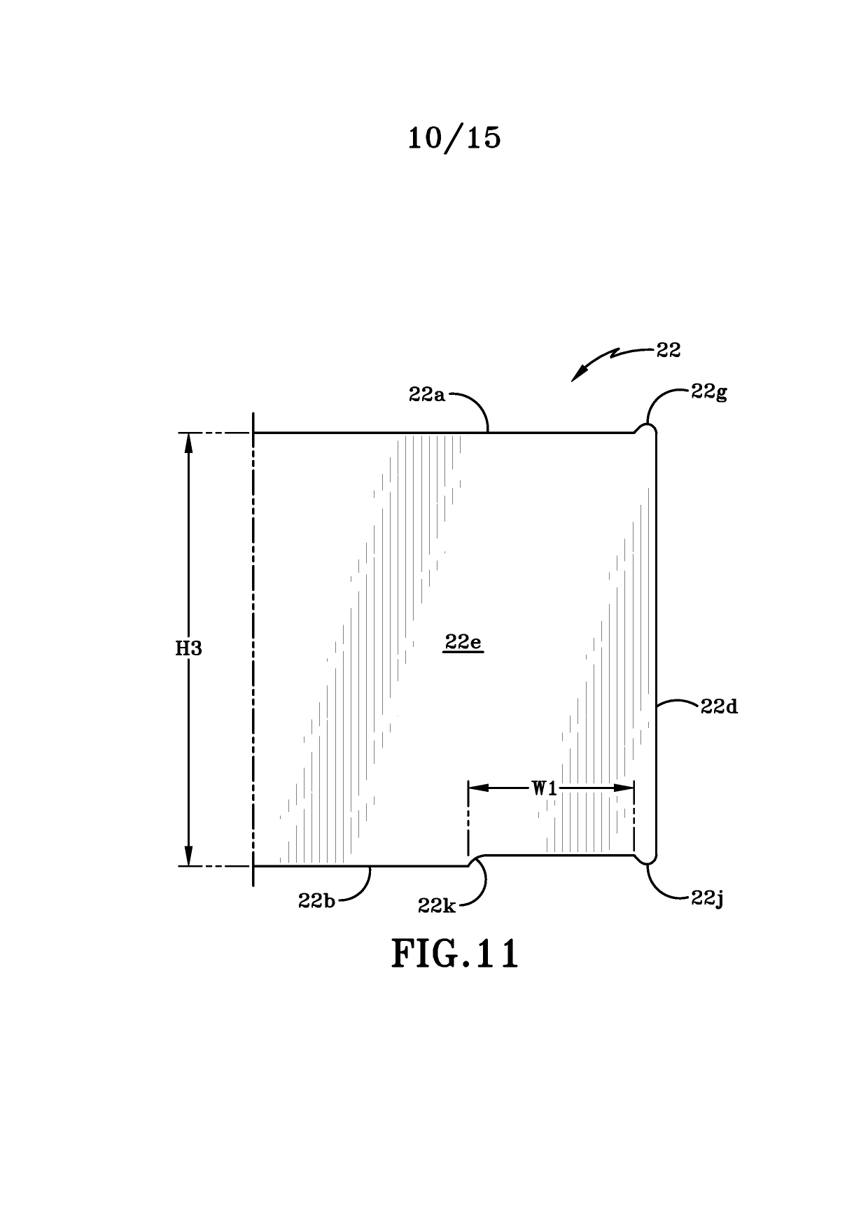

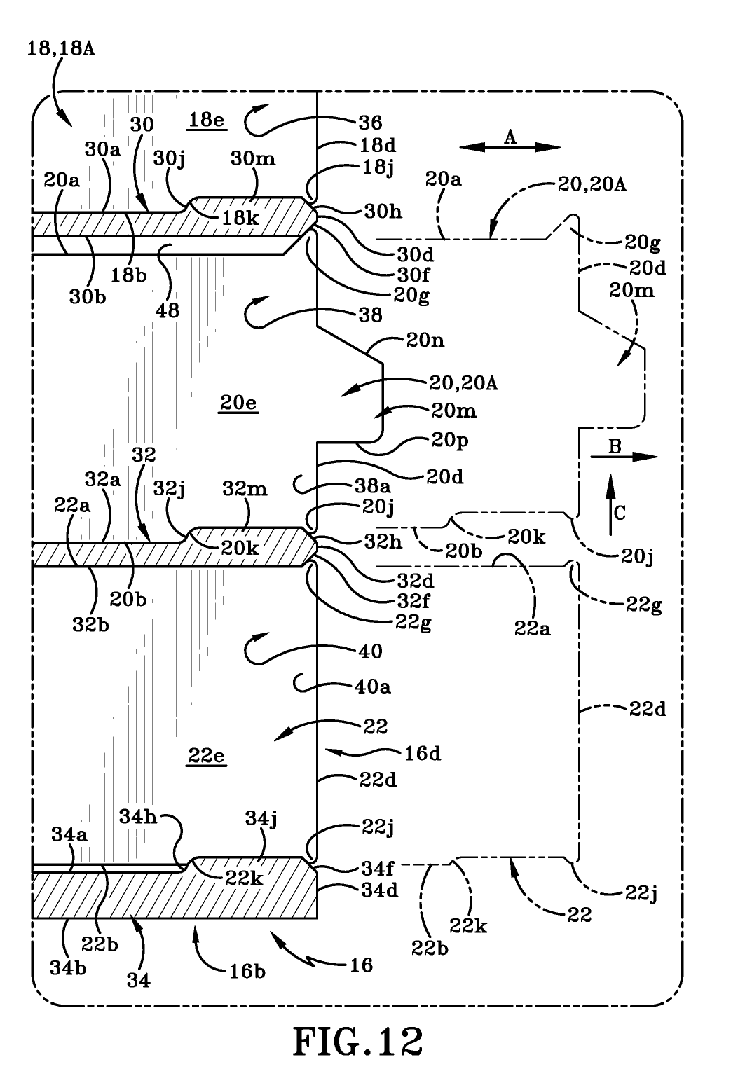

FIGS. 10 and 11 show the third card 22. Card 22 has an upper edge 22a, a lower edge 22b, a first side 22c, a second side 22d, and a front surface 22e (a rear surface is located opposite front surface 22e but is not illustrated herein). Card 22 may be of a height “H3” defined as the distance between upper edge 22a and lower edge 22b. Height “H3” may be shorter than length “L3” of third pocket 40.

Upper edge 22a meets first side 22b at a first corner 22f. First corner 22f is a gently rounded projection that extends upwardly and outwardly from upper edge 22a. Upper edge 22a meets second side 22d at a second corner 22g. Second corner 22g is again a gently rounded projection that extends upwardly and outwardly beyond the rest of upper edge 22a, except for the projection of first corner 22f. First and second corners 22f, 22g may be of substantially the same size.

Lower edge 22b meets first side 22c at a third corner 22h that is a gently rounded projection that is similar to first corner 22f except the projection extends outwardly and downwardly from lower edge 22b. Third corner 22h is part of a first recessed region on lower edge 22b that is generally complementary in shape to first projection 34i on fourth spacer 30. A first shoulder 22i is provided a distance inwardly from third corner 22h and first shoulder 22i is complementary to first shoulder 34g on fourth spacer 34. Lower edge 22b meets second side 22d at a fourth corner 22j. The fourth corner 22j includes a small rounded projection that extends downwardly and outwardly from lower edge 22b and is positioned and sized to engage second chamfer 34f on fourth spacer 34. Fourth corner 22j may be of substantially the same shape and size as the projection of third corner 22h. Fourth corner 22j is part of a second recessed region on lower edge 22b. A second shoulder 22k is provided a distance inwardly from fourth corner 22j and is complementary to second shoulder 34h on fourth spacer 34. First and second recessed regions may be of a width “W1” (FIG. 10). It should be noted that no tab extends outwardly from either of the first and second sides 22c, 22d of third card 22.

FIG. 12 shows cards 18A, 20A and 22 engaged in housing 16. The rear wall (26) has been removed from this figure for clarity of illustration. Card 18A is engaged in first pocket 36 and there is a type of interlocking engagement of second shoulder 30j on second spacer 30 and second shoulder 18k on card 18A. (Although not illustrated in FIG. 12, there is a similar interlocking engagement of first shoulder 30i on second spacer 30 and first shoulder 18i of card 18A.) This interlocking engagement restricts the movement of card 18A in a lateral direction indicated by arrow “A” in this figure. Furthermore, the projection 18j on card 18A abuts second chamfer 30f. Second chamfer 30f acts a stop for movement of the card toward first side 16c of housing 16. Although not illustrated in this figure, the triangular projection 18g (FIG. 7) on card 18A will come into contact with second chamfer 28f on first spacer 28. This engagement of projection 18g and second chamfer 28f also prevents further movement of card 18A toward first side 16c of housing 16.

FIG. 12 also shows card 20A engaged in second pocket 38. Again, there is interlocking engagement of card 20A and third spacer 32. In particular, shoulders 20k on card 20A and 32g on third spacer 32 are in abutting contact (as are the shoulders 20i and 32i); triangular projection 20g abuts second chamfer 30f on second spacer 30 and projection 20j on card 20A abuts second chamfer 32f on third spacer 32. It should be noted that when card 20A is engaged in second pocket 38, a gap 48 is defined between upper edge 20a of card 20A and lower edge 30b of second spacer 30. (A similar gap is defined between upper edge 18a of card 18A and lower edge 28b of first spacer 28.)

In order to remove card 20A from its interlocking engagement in second pocket 38, tab 20m is pulled in the direction of arrow “B”. This motion causes second shoulder 20k of card 20A to ride upwardly along second shoulder 32g thereby causing card 20A to move upwardly in the direction of arrow “C” (FIG. 12). When in this raised position, upper edge 20a of card 20A is proximate lower edge 30b of second spacer 30 and card 20A. In other words, the gap 48 is closed and card 20A is then free to be withdrawn from second pocket 38. When card 20A is inserted into second pocket 38, the opposite motion of card 20A occurs. Card 20A is introduced into second pocket 38 and moved in the opposite direction to arrow “B” and further into second pocket 38, the upper edge 20a thereof slides along lower edge 30b of second spacer 30 until second shoulder 20k slides downwardly along second shoulder 32g of third spacer 32. Card 20A then drops downwardly in the opposite direction of arrow “C” and gap 48 once again opens up. It should be noted that card 18A experiences the same types of changes in vertical position relative to the lower edge 28b of first spacer 28 when card 18A is inserted or removed from housing 16.

Cards 18 and 20 are considered to be readily changeable cards and are configured to be relatively easily inserted and removed from housing 16. Card 22, on the other hand, is configured so that it is relatively permanently engaged in housing 16. It is not contemplated that card 22 will be changed frequently. In order to aid in ensuring that card 22 remains substantially permanently engaged in housing 16 and is not accidentally withdrawn therefrom, card 22 does not include a tab similar to tabs 18n or 20n. Furthermore, card 22 is of a substantially similar size relative to third pocket 40, i.e., the height “H3” of card 22 is substantially similar to the length “L3” of third pocket 40. Consequently, when card 22 is inserted into third pocket 40 the card 22 slides over the uppermost surface of projection 34j and when shoulder 22k of card 22 slides down shoulder 34h of fourth spacer 34, card 22 becomes substantially wedged between shoulder 34g and shoulder 34h. If a person tried to remove card 22, it can be done, but card 22 is reasonably difficult to grab hold of and has to be slightly deformed in order to withdraw it from third pocket 40.

It will be understood that first, second and third pockets 36, 38, 40 may be sized differently to what has been illustrated herein. So, for instance, first pocket 36 may be of a size that is closer to second pocket 38 or third pocket 40; and one or the other of second pocket 38 and third pocket 40 may be larger than is illustrated herein. It will be understood that the size of the cards 18, 20, 22 that are to be received in the differently sized first, second or third pockets 36, 38, 40, will be changed to be complementary to the pocket into which a particular card is to be received.

So, for example, FIG. 13 shows a second embodiment of a card that is to be received in a differently sized third pocket. This card 122 is configured as a semi-permanent card. Card 122 includes all of the features of card 22 but is of a height “H4” instead of a height “H3”. Card 122 has an upper edge 122a, a lower edge 122b, a first side 122c, a second side 122d, and a front surface 122e (a rear surface is located opposite front surface 122e but is not illustrated herein). Upper edge 122a meets first side 122b at a first corner 122f. First corner 122f is a gently rounded projection that extends upwardly and outwardly from upper edge 122a. Upper edge 122a meets second side 122d at a second corner 122g. Second corner 122g is again a gently rounded projection that extends upwardly and outwardly beyond the rest of upper edge 122a, except for the projection of first corner 122f. First and second corners 122f, 122g may be of substantially the same size.

Lower edge 122b meets first side 122c at a third corner 122h that is a gently rounded projection that is similar to first corner 122f except the projection extends outwardly and downwardly from lower edge 122b. Third corner 122h is part of a first recessed region on lower edge 122b that is generally complementary in shape to first projection 34i on fourth spacer 30. A first shoulder 122i is provided a distance inwardly from third corner 122h and first shoulder 122i is complementary to first shoulder 34g on fourth spacer 34. Lower edge 122b meets second side 122d at a fourth corner 122j. The fourth corner 122j includes a small rounded projection that extends downwardly and outwardly from lower edge 122b and is positioned and sized to engage second chamfer 34f on fourth spacer 34. Fourth corner 122j may be of substantially the same shape and size as the projection of third corner 122h. Fourth corner 122j is part of a second recessed region on lower edge 122b. A second shoulder 122k is provided a distance inwardly from fourth corner 122j and is complementary to second shoulder 34h on fourth spacer 34. First and second recessed regions may be of a width “W1”. It should be noted that no tab extends outwardly from either of the first and second sides 122c, 122d of third card 22.

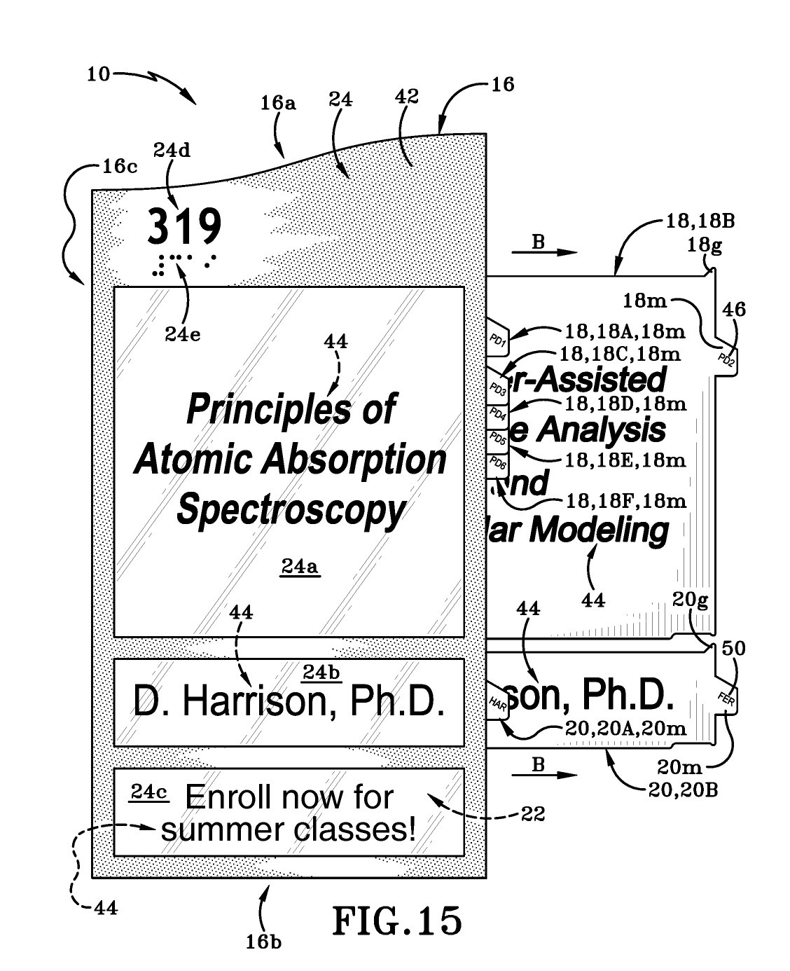

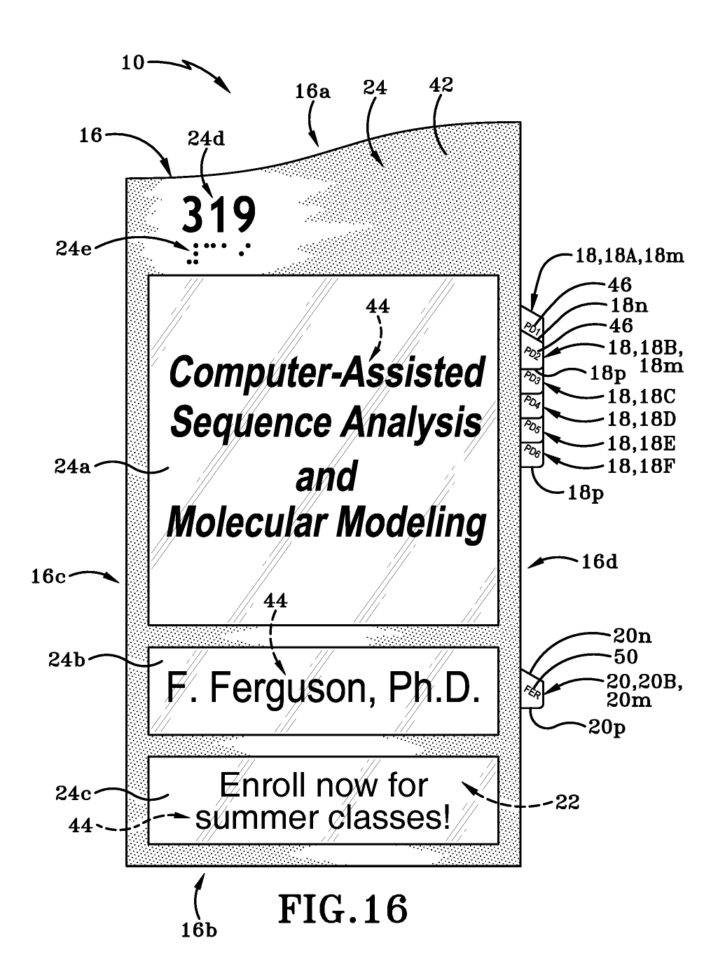

FIGS. 14-16 illustrate cards 18A and 20A being replaced with cards 18B and 20B. Display sign 10 is illustrated as having the graphic and/or textual information 44 on first card 18A visible through first window 24a on housing and the graphic and/or textual information 44 on second card 20A visible through second window 24b. The graphic or textual information 44 on third card 22 is visible through third window 24c. FIG. 14 shows that the various tabs of the plurality of cards 18 retained within the first pocket of housing 16 can be readily seen since they project outwardly beyond second side 16d of housing 16. As discussed earlier herein, tabs 18n of the various cards 18A-18B have informational text or images 46 thereon and this text is oriented at an angle. Furthermore, no text 46 is provided on regions of the tabs 18n that are covered by another of the tabs. It is therefore easy for a user to determine which card 18 to remove from first pocket 36 and insert in front of card 18A. So, for example, the user may select card 18B (FIG. 15) and withdraw the same from housing 16 in the direction of arrow “B” and then insert card 18B into the first pocket 36 and in front of card 18A. This insertion occurs in the direction of arrow “D” (FIG. 16).

The user may also determine that the information on card 20A is no longer relevant in light of the change in the card displayed in the first pocket. All of the tabs 20m also contact textual or graphic information 50. The tabs 20m are illustrated as all being located one-in-front of the other instead of in a staggered fashion as with cards 18. As a result, the user changing the display sign 10 will have to withdraw some or all of the cards 20 or will need to move the tabs 20m in such a fashion that they are able to read the informational text 50 on the various tabs 20m and select the tab that displays the information they seek. The desired tab 20m will be pulled outwardly from housing 16 in the direction of arrow “B” (as is illustrated in FIG. 15) and then that selected card 20B in this instance, will be inserted in front of card 20A in the second pocket 38 of housing 16 and pushed inwardly in the direction of arrow “D” until seated in second pocket 38. As discussed earlier, the second chamfers 30h on second spacer 30 and the second chamfer 32f on third spacer 32 will limit the extent of travel of the cards 18B and 20B toward first side 16a of housing 16.

The information 44 shown on third card 22 remains relevant no matter which of the cards 18A-18F is displayed and no matter which of the cards 20A-20F is displayed. Third card 22 is therefore not withdrawn from housing 16.

It will be understood that instead of cards 18A-18F and 20A-20F being insertable into the pockets through openings in the second side 16d of housing 16, cards 18A-18F and 20A-20F may be configured so that the tabs 18m, 20m thereon extend outwardly from the first sides 18c 20c of the cards instead of from the second sides 18d, 20d thereof. All other structures on cards 18 and 20 will also be reversed so that the travel of the cards toward second side 16d of housing can be limited by the various projections on the cards engaging the first chamfers 30g, 32g on second and third spacers 30, 32.

Furthermore, the tabs 18m on cards 18A-18F may not be staggered but may instead be overlapped in a manner similar to the overlapping (i.e. one-in-front of the other) configuration of tabs 20m. Similarly, instead of tabs 20m overlapping each other as shown herein, tabs 20m may be staggered in a similar manner to the illustrated tabs 18m. Still further, tabs 18m, 20m may be provided on each of first and second sides 18c 18d and 20c, 20d of the cards 18, 20. Furthermore, tabs 18m, 20m may provided on alternating opposite sides of the cards. So, for example, card 18A may have its tab 18m extending outwardly from second side 18d of the card 18A, while card 18B may have its tab 18m extending outwardly from first side 18c of that card 18B.

It will be understood that while first window 24a, second window 24b, and third window 24c and the associated first pocket 36, second pocket 38 and third pocket 40 have been disclosed as being positioned one above the other to effectively form a vertical column in housing 16, the windows 24a-24c and pockets may be located in any desired configuration relative to each other. So, for example, two of the windows and associated pockets may be located side-by-side and the other window and associated pocket may be located above or below the two side-by-side windows and pockets.

It will further be understood that any number of windows and associated pockets may be provided in housing 16. So, for example, only a single window and associated single pocket may be provided in housing; or only two windows and associated pockets may be provided therein or more than three windows and pockets may be provided.

Furthermore, the type of display cards 18, 20, 22 utilized in housing 16 may differ from what has been described herein. Some or all of the cards may be configured to be arranged as a stack or set of display cards that may be individually selectively withdrawn and rearranged within sign 10, in the manner described with reference to cards 18 or 20. Some or all of the cards may be single display cards that are substantially permanently retained within housing 16. Alternatively, only a single display card may be inserted into one of the pockets in housing 16 but that single display card may have the configuration of display card 18 or 20 so that it is readily and easily withdrawn from housing 16.

The changeable sign 10 disclosed herein may be used as follows. The first step if the provision of a sign 10 comprising a housing 16 having a front wall 24 and a rear wall 26; a first pocket 36 defined in housing 16; a first window 24a provided on front wall 24, wherein an interior of first pocket 24a is visible through the first window 24a. The method includes inserting a first set of display cards 18 into first pocket 36; where first set of display cards 18 includes one or more display cards 18A, 18B etc. that have different graphic images or text 44 thereon; positioning an outermost display card (such as 18A) of the one or more display cards 18A-18F adjacent first window 24a; displaying the text or graphics 44 on outermost display card 18A through first window 24a; selecting another of the one or more display cards, such as 18B, from a remaining portion of first set of display cards 18; removing the selected one of the display cards 18B from first pocket 36; and inserting the removed display card 18B in front of the outermost display card 18A; displaying the text or graphics 44 on the inserted display card 18B through first window 24a. 24. It should be noted that display cards 18A-18B in the first set of display cards (and display cards 20A-20F in second set of display cards 20) are selectively individually removable from the first pocket 36 (or second pocket 38) are selectively individually removable and/or insertable into the first pocket 36 (or second pocket 38).

The step of removing the selected one of the display cards 18B includes grasping a tab 18m provided on the selected one of the display cards 18B; pulling on the grasped tab (in the direction of arrow “B”—FIG. 15) and sliding the selected one of the display cards 18B out of first pocket 36. The step of providing housing 16 further comprises providing at least one additional pocket 38 or 40 in housing 16; wherein the at least one additional pocket is separated from first pocket 36; providing at least one additional window 24b or 24c, respectively, on front wall 24 of housing 16; wherein an interior of the at least one additional pocket 38 or 40 is visible through the at least one additional window 24b or 24c; and the method further comprises selecting one of the at least one additional pockets (40 for example); inserting at least a single display card 22 into the selected one of the at least one additional pockets 40; and semi-permanently interlocking the inserted single display card 22 into the selected one of the at least one additional pockets 40.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration set out herein are an example not limited to the exact details shown or described.

1. (canceled)

2. The changeable sign as defined in claim 15, wherein a tab extends outwardly from a side edge of each of the one or more display cards; and when the set of display cards is received in the pocket, the tab of each of the one or more display cards extends outwardly beyond a side edge of the front wall of the housing.

3. The changeable sign as defined in claim 2, wherein the tab of each of the one or more display cards is located at a distance from the upper edge thereof; and wherein the distance of the tab from the upper edge of each of the one or more display cards in the set of display cards differs from the distances of the tabs of all other display cards in the set of display cards.

4. The changeable sign as defined in claim 3, wherein when the set of display cards is received in the pocket, the tabs of all of the one or more display cards in the set of display cards are staggered relative to each other.

5. The changeable sign as defined in claim 4, further comprising text or images provided on each tab; and when the set of display cards is received in the pocket, the text or images on all the tabs is visible no matter an order of the display cards in the set of display cards.

6. The changeable sign as defined in claim 5, wherein the text or images on each tab is oriented at an angle relative to the side edge of an associated one of the one or more display cards from which the tab extends.

7. (canceled)

8. (canceled)

9. The changeable sign as defined in claim 15, wherein the first limiting member is located at a junction of the upper edge of the associated display card and one of the first side and the second side thereof; and the first limiting member extends upwardly for a distance beyond the upper edge of the associated display card.

10. The changeable sign as defined in claim 15, wherein the first limiting member is located at a junction of the lower edge of the associated display card and one of the first side and the second side thereof; and the first limiting member extends downwardly for a distance beyond the lower edge of the associated display card.

11. (canceled)

12. (canceled)

13. (canceled)

14. (canceled)

15. A changeable sign comprising:
a housing having:
a front wall with an upper edge, a lower edge, a first side and a second side;
a rear wall, with an upper edge, a lower edge, a first side, and a second side;
a first spacer and a second spacer positioned between the front wall and the rear wall, wherein the second spacer is located a distance away from the first spacer;
a pocket defined between an interior surface of the front wall and an interior surface of the rear wall of the housing and between the first spacer and the second spacer;
a window provided on the front wall, wherein an interior of the pocket is visible through the window;
one or more display cards shaped and sized to be received in the pocket, wherein each of the one or more display cards has an upper edge, a lower edge, a first side, and a second side, and wherein each of the one or more display cards has different text or images thereon;
wherein one of the upper edge or the lower edge includes a first limiting member and the other of the upper edge and the lower edge includes a second limiting member; and the first limiting member selectively engages a portion of the housing when an associated display card is inserted into the pocket and the first limiting member limits a degree of insertion of the associated display card into the pocket; wherein the first limiting member engages a region of one of the first spacer and the second spacer; and the second limiting member engages a region on the other of the first spacer and the second spacer and wherein the regions of the one of the first and second spacers engaged by the first limiting member or the second limiting member is a chamfer that angles inwardly toward the interior of the pocket;
a shoulder provided on the lower edge of each of the one or more display cards, said shoulder being located a distance inwardly from one of the first side or the second side of the associated display card; and
a shoulder provided on the second spacer, wherein the spacer's shoulder is located a distance inwardly from the chamfer; and wherein the display card's shoulder and the spacer's shoulder are complementary and selectively interlock the associated display card and the housing together; and wherein the one or more display cards form a set of display cards that is receivable in the pocket; and when the set of display cards is so received, the text or images on an outermost display card of the set of display cards is visible through the window.

16. The changeable sign as defined in claim 15, further comprising:
a second pocket defined in the housing, said second pocket being separated from the pocket; and
a second window provided on the front wall of the housing, wherein an interior of the second pocket is visible through the second window.

17. The changeable sign as defined in claim 16, further comprising:
one or more second display cards, wherein each second display card is shaped and sized to be received in the second pocket and has different text or images thereon; and wherein the one or more second display cards form a set of second display cards that is received in the second pocket; and when the set of second display cards are so received, the text or images on an outermost one of the one or more second display cards is visible through the second window.

18. The changeable sign as defined in claim 17, wherein each of the one or more second display cards has an upper edge, a lower edge, a first side and a second side; wherein a tab extends outwardly from one of the first side or the second side of the one or more second display cards; and when the set of second display cards is received in the second pocket, the tab on each of the one or more second display cards extends outwardly beyond a side of the housing.

19. The changeable sign as defined in claim 17, wherein each of the one or more second display cards includes an upper edge, a lower edge, a first side and a second side; wherein one of the upper edge or the lower edge of each of the one or more second display cards has a limiting member that engages a portion of the housing when an associated second display card is inserted into the second pocket; and wherein the limiting member limits a degree of insertion of the associated second display card into the second pocket.

20. (canceled)

21. The changeable sign as defined in claim 16, further comprising:
a third pocket defined in the housing, said third pocket being separated from the pocket and the second pocket; and
a third window provided on the front wall of the housing, wherein an interior of the third pocket is visible through the third window.

22. The changeable sign as defined in claim 21; further comprising:
one or more second display cards that are selectively receivable in the second pocket; wherein each of the one or more second display cards has an upper edge, a lower edge, a first side and a second side; and wherein a tab extends outwardly from the first side or the second side of each of the one or more second display cards and outwardly beyond a side of the housing when the one or more second display cards are received in the second pocket; and wherein the one or more second display cards is selectively individually removable from the second pocket or insertable into the second pocket; and
a single third display card shaped and sized to be received within the third pocket; wherein the third display card is free of tabs and is semi-permanently retained within the third pocket.

23. The changeable sign as defined in claim 15, further comprising:
at least one additional pocket defined in the housing; wherein the at least one additional pocket is separated from the pocket;
at least one additional window provided on the front wall; wherein an interior of the at least one additional pocket is visible through the at least one additional window; and
at least one additional set of display cards shaped and sized to be received in one of the one or more additional pockets;
wherein each display card in the set of display cards or in the at lest one additional set of display cards has different text or images thereon; and when the set of display cards is received in the pocket, the text or images on an outermost display card of the set of display cards is visible through the window; and the different text or images on an outermost display card of the at least one additional set of display cards is visible through the at least one additional window.

24. The changeable sign as defined in claim 23, wherein display cards in the additional set of display cards are semi-permanently engaged in at least one of the one or more additional pockets.

25. A method of changing information displayed on a wall sign; said method comprising the steps of:
providing a changeable sign comprising a housing having a front wall with an upper edge, a lower edge, a first side and a second side; a rear wall, with an upper edge, a lower edge, a first side, and a second side; a first spacer and a second spacer positioned between the front wall and the rear wall, wherein the second spacer is located a distance away from the first spacer; a pocket defined between an interior surface of the front wall and an interior surface of the rear wall of the housing and between the first spacer and the second spacer; a window provided on the front wall, wherein an interior of the pocket is visible through the window; a first set of display cards shaped and sized to be received in the pocket, wherein each of the one or more display cards has an upper edge, a lower edge, a first side, and a second side, and wherein each of the one or more display cards has different text or images thereon; wherein one of the upper edge or the lower edge includes a first limiting member and the other of the upper edge and the lower edge includes a second limiting member; and the first limiting member selectively engages a portion of the housing when an associated display card is inserted into the pocket and the first limiting member limits a degree of insertion of the associated display card into the pocket; wherein the first limiting member engages a region of one of the first spacer and the second spacer; and the second limiting member engages a region on the other of the first spacer and the second spacer and wherein the regions of the one of the first and second spacers engaged by the first limiting member or the second limiting member is a chamfer that angles inwardly toward the interior of the pocket; a shoulder provided on the lower edge of each of the one or more display cards, said shoulder being located a distance inwardly from one of the first side or the second side of the associated display card; and a shoulder provided on the second spacer, wherein the spacer's shoulder is located a distance inwardly from the chamfer; and wherein the display card's shoulder and the spacer's shoulder are complementary and selectively interlock the associated display card and the housing together; and wherein the one or more display cards forms a first set of display cards that is receivable in the pocket; and when the first set of display cards is so received, the text or images on an outermost display card of the set of display cards is visible through the window;
inserting the first set of display cards into the first pocket;
positioning an outermost display card of the first set of display cards adjacent the first window;
selectively interlocking the outermost display card's shoulder with the spacer's shoulder;
interlocking the outermost display card and the spacer's shoulder together;
displaying the text or graphics on the outermost display card through the first window.

26. The method as defined in claim 25, further comprising:
selecting one of the one or more display cards from a remaining portion of the first set of display cards;
removing the selected one of the display cards from the first pocket; and
inserting the removed display card in front of the outermost display card;
selectively interlocking the inserted display card's shoulder with the spacer's shoulder;
interlocking the inserted display card and the spacer's shoulder together;
displaying the text or graphics on the inserted display card through the first window.
